(19) United States
(12) Patent Application Publication
(10) Pub. No.: US 2026/0014531 A1
(43) Pub. Date: Jan. 15, 2026

(54) SOLID CHEMICAL DISSOLUTION SYSTEM WITH SMALL FOOTPRINT AND LIMITED OFFGASSING

(71) Applicant: Ecolab USA Inc., Saint Paul, MN (US)

(72) Inventors: Seth Michael Detjens, Woodbury, MN (US); Kenneth Thomas Dobizl, Stillwater, MN (US); Tyler William Wyvell, Minneapolis, MN (US)

(21) Appl. No.: 19/267,038

(22) Filed: Jul. 11, 2025

Related U.S. Application Data
(60) Provisional application No. 63/669,795, filed on Jul. 11, 2024.

(51) Int. Cl. B01F 21/20; B01F 21/00; B01F 25/51; B01F 35/221; B01F 35/30

(52) U.S. Cl. CPC B01F 21/221; B01F 21/30; B01F 25/51; B01F 35/2211; B01F 2035/351; B01F 2215/0427; B01F 2215/0431

(57) ABSTRACT

A system for dissolving solid chemical to form a dilute liquid solution can include a solid chemical reservoir and a solution generator reservoir. The solid chemical reservoir can have a product support surface and be configured to allow diluent to flow therethrough. The solution reservoir can be positioned below the solid chemical reservoir. A liquid blocking wall can be positioned between the product support surface and an interior of the solution reservoir to define a liquid filling space therebetween. The system can include a recirculation circuit having an outlet in the liquid filling space. The recirculation circuit can draw liquid from the solution reservoir and discharge the liquid through the outlet into the filling space, thereby causing the liquid to flow through the product support surface to contact the solid chemical before discharging through an opening of the solid chemical reservoir and back into the solution reservoir.

### RELATED APPLICATION

This application claims priority to U.S. Provisional Application No. 63/669,795, filed Jul. 11, 2024, the entire contents of which are hereby incorporated by reference.

### TECHNICAL FIELD

This disclosure relates to systems for dissolving solid chemicals to generate liquid solutions.

### BACKGROUND

Chemical product dispensers are useful in many different chemical application systems, including water treatment systems like commercial cooling water systems, cleaning systems relating to food and beverage operations, laundry operations, warewashing operations (e.g., dishwashers), pool and spa maintenance, as well as other systems, such as medical operations. For example, chemical products used in water treatment systems may include oxidizing and non-oxidizing biocides to inhibit or destroy growth or activity of living organisms in the water being treated. As another example, chemical products used in food and beverage operations may include sanitizers, sterilants, cleaners, degreasers, lubricants, etc. Chemical products used in a warewashing or laundry operation may include detergent, sanitizers, stain removers, rinse agents, etc. Chemical products used in a laundry operation may include detergent, bleaches, stain removers, fabric softeners, etc. Chemical products used in cleaning of medical/surgical instrumentation may include detergents, cleaning products, neutralizers, sanitizers, disinfectants, enzymes, etc.

For low volume and non-commercial applications, chemical products are often provided in ready-to-use form. The chemical product may be formulated at the correct concentration for the intended application and may be applied directly without diluting or otherwise modifying the chemical composition of the product. In other applications, such as high-volume use facilities and commercial applications, a desired chemical product may be formed on site from one or more concentrated chemical components. The concentrated chemical may be introduced into a dispenser system where the chemical is contacted with water to form a dilute, ready-to-use solution.

### SUMMARY

In general, this disclosure is directed to devices, systems, and techniques for generating liquid solutions from concentrated solid chemicals. In some examples, the generator system is configured with two reservoirs positioned in a vertically stacked arrangement relative to each other. For example, the system may include a solid chemical reservoir configured to receive solid chemical to be dissolved. The system may also include a solution reservoir positioned vertically below the solid chemical reservoir. The system can include an arrangement of features to supply diluent to dissolve at least a portion of the solid chemical in the solid chemical reservoir, forming a dilute chemical solution that is held in the solution reservoir until being discharged to a downstream application.

For example, the system can include a product support surface bounding a lowermost extent of the solid chemical reservoir. Solid product at the bottom of the solid product reservoir can contact and rest on the product support surface. The system can also include a liquid blocking wall positioned between the product support surface of the solid chemical reservoir and an interior of the solution reservoir. A liquid filling space can be formed between the liquid blocking wall and the product support surface of the solid chemical reservoir. In operation, a recirculation circuit of the system can draw liquid from held in the solution reservoir and discharge the liquid into the filling space. The liquid can flow upwardly through apertures extending through the thickness of the product support surface, contacting and wetting solid chemical held on the product support surface. This can cause at least a portion of the contacted/wetted solid chemical to dissolve, increasing a concentration of one or more chemical agents forming the solid chemical in the liquid solution. The liquid solution can then be discharged from the liquid filling space back into the solution reservoir.

A generator system can have a variety of different configurations and advantages, as described herein. In some implementations, the generator system is designed with a comparatively small footprint, minimizing the amount of floor space the generator system occupies at a location of use. For example, by arranging features of the generator system in a vertically stacked arrangement, the area of the generator system may be reduced, which can be particularly helpful for space-constrained applications. Additionally or alternatively, the generator system may include a frame containing the solution reservoir, which the solution reservoir is configured with an asymmetric shape providing a pocket within the footprint of a larger section of the solution reservoir. For example, the solution reservoir may be configured with an upper portion defining a first cross-sectional area and a lower section defining a second cross-sectional area less than the first cross-sectional area (e.g., with the pocket provided by the space difference between the first and second cross-sectional areas). One or more features of the generator system (e.g., one or more pumps, controllers, valves) may be located in the pocket, again helping to provide a system with a compact cross-sectional area.

In some examples, the generator system is additionally or alternatively configured to minimize offgassing. Offgassing may occur during use of the generator system or, more commonly, between uses when the generator system is not actively recirculating diluent to dilute solid product. During operation, a portion of the solid product in the generator can be wetted to cause dissolution of the solid product. At the end of a generation cycle, residual wetted solid product may remain in the generator. This wetted solid product may release odiferous vapors as the product dries. In some configurations of the present disclosure, the generator may be configured to help minimize such offgassing. For example, the amount of solid product wetted during operation may be comparatively small (e.g., such that only a small height of product is wetted during operation of the generator), helping to minimize the amount of residual wetted product offgassing following a generation cycle. Additionally or alternatively, the generator may include one or more seals and/or other features to help minimize gas exchange between an interior of the generator and an exterior environment. A generator system can have a variety of different features and configurations, as described herein.

In one example, a system for dissolving solid chemical is described. The system includes a solid chemical reservoir configured to receive a solid chemical to be dissolved. The solid chemical reservoir has a product support surface having a plurality of apertures, which can be sized smaller than the solid chemical, and configured to allow diluent to flow upwardly therethrough, at least one sidewall extending vertically upwardly from the product support surface, and a liquid outlet opening extending through the at least one sidewall that is offset from the product support surface. The example system also includes a solution reservoir positioned vertically below the solid chemical reservoir with the liquid outlet opening of the solid chemical reservoir being in fluid communication with the solution reservoir. The example system further includes a liquid blocking wall positioned between the product support surface of the solid chemical reservoir and an interior of the solution reservoir to define a liquid filling space between the liquid blocking wall and the product support surface of the solid chemical reservoir. In addition, the example specifies that the system includes a recirculation circuit that includes a recirculation pump and a recirculation line having an outlet in the filling space between the liquid blocking wall and the product support surface of the solid chemical reservoir. The recirculation circuit is configured to draw liquid from the solution reservoir and discharge the liquid through the outlet of the recirculation line into the filling space, thereby causing the liquid to flow upwardly through the plurality of apertures of the product support surface to contact the solid chemical thereon before discharging through the liquid outlet opening back into the solution reservoir.

In another example, a method is described that includes introducing a solid chemical into a solid chemical reservoir comprising at least one sidewall and a liquid outlet opening extending through the at least one sidewall. The example method also includes introducing water into a solution reservoir positioned vertically below the solid chemical reservoir. The method further involves recirculating liquid from the solution reservoir by drawing the liquid from the solution reservoir and discharging the liquid through an outlet of a recirculation line into a filling space positioned between a product support surface on which the solid chemical resides and a liquid blocking wall, thereby causing the liquid to flow upwardly through a plurality of apertures of the product support surface and to contact the solid chemical thereon before discharging through the liquid outlet opening and back into the solution reservoir. The method additionally includes discharging a generated chemical solution from the solution reservoir to a downstream location.

In some implementations, a system for dissolving solid chemical includes a recirculation circuit that includes a recirculation pump and a recirculation line having an outlet above a product support surface of the solid chemical reservoir. The recirculation circuit may be configured to draw liquid from the solution reservoir and discharge the liquid through an outlet of the recirculation line above the product support surface of the solid chemical reservoir, thereby causing the liquid to contact the solid chemical thereon to flow downwardly through the plurality of apertures of the product support surface before discharging through the liquid outlet opening back into the solution reservoir.

In an example, a method is described that includes introducing a solid chemical into a solid chemical reservoir comprising at least one sidewall and a liquid outlet opening extending through the at least one sidewall. The example method also includes introducing water into a solution reservoir positioned vertically below the solid chemical reservoir. The method further involves recirculating liquid from the solution reservoir by drawing the liquid from the solution reservoir and discharging the liquid through an outlet of a recirculation line positioned above a product support surface on which the solid chemical resides, thereby causing the liquid to contact the solid chemical thereon to flow downwardly through a plurality of apertures of the product support surface into a filling space positioned between the product support surface and a liquid blocking wall before discharging through the liquid outlet opening back into the solution reservoir.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system for dissolving solid chemical.

FIG. 2 is a perspective of an example configuration of the system from FIG. 1.

FIG. 3 is a side sectional view of an example configuration of the system from FIG. 1

FIG. 4A is a perspective view of an example configuration of an example solid chemical reservoir isolated from surrounding features of the system.

FIG. 4B is a side sectional view of a portion of the example solid chemical reservoir showing an example arrangement of features.

FIG. 4C is a perspective view of an example insert that can be inserted into the example solid chemical reservoir to provide a product support surface on which solid chemical resides during use.

FIGS. 5A and 5B are different perspective views of an example configuration of a solution reservoir.

FIGS. 6A-6C are side views of an example generator system showing different example liquid flows using the system during a generation cycle and subsequent discharge from the system.

### DETAILED DESCRIPTION

A variety of chemicals are provided to end users in concentrated form to reduce the weight and volume of the chemicals during shipping and storage. Once delivered to a location of intended use, however, a concentrated chemical is combined with a diluent such as water to produce a diluted chemical solution, which may be referred to as a use solution or just “solution” herein. Depending on the composition of the concentrated chemical, the use solution can be used for any number applications such as hard surface sanitation, food and beverage operations, laundry operations, warewashing operations, water treatment operations (e.g., cooling tower biocidal control), pool and spa maintenance, agricultural operations, and the like.

In general, this disclosure describes chemical dilution systems (also referred to as chemical generator systems) and techniques. In some examples, the system includes a solid chemical reservoir that holds solid chemical to be dissolved to form a target solution. The solid chemical reservoir may be partially or fully enclosed within a solution reservoir that is filled with diluent to erode the solid chemical and form the solution. A liquid filling space may be formed between a liquid blocking wall positioned between a product support surface on which solid product introduced into the solid chemical reservoir resides and an interior of the solution reservoir. A recirculation circuit may be provided that recirculates diluent initially introduced into the solution reservoir from the solution reservoir to the liquid filling space. The recirculation circuit can draw liquid from the solution reservoir and discharge pressurized liquid through an outlet of a recirculation line into the liquid filling space, thereby causing the liquid to flow upwardly through apertures of the product support surface to contact the solid chemical thereon. After contacting solid product on the product support surface (and dissolving a portion of the solid product), the liquid can discharge through a liquid outlet opening extending through a sidewall of the solid chemical reservoir and back into the solution reservoir.

In another example, systems and techniques are described that include introducing a solid chemical into a solid chemical reservoir comprising at least one sidewall and a liquid outlet opening extending through the at least one sidewall. The examples include introducing water into a solution reservoir positioned vertically below the solid chemical reservoir. The example systems and techniques can involve recirculating liquid from the solution reservoir by drawing liquid from the solution reservoir and discharging the liquid through an outlet of a recirculation line positioned above a product support surface on which the solid chemical resides, thereby causing the liquid to contact the solid chemical thereon to flow downwardly through a plurality of apertures of the product support surface into a filling space positioned between the product support surface and a liquid blocking wall before discharging through the liquid outlet opening back into the solution reservoir.

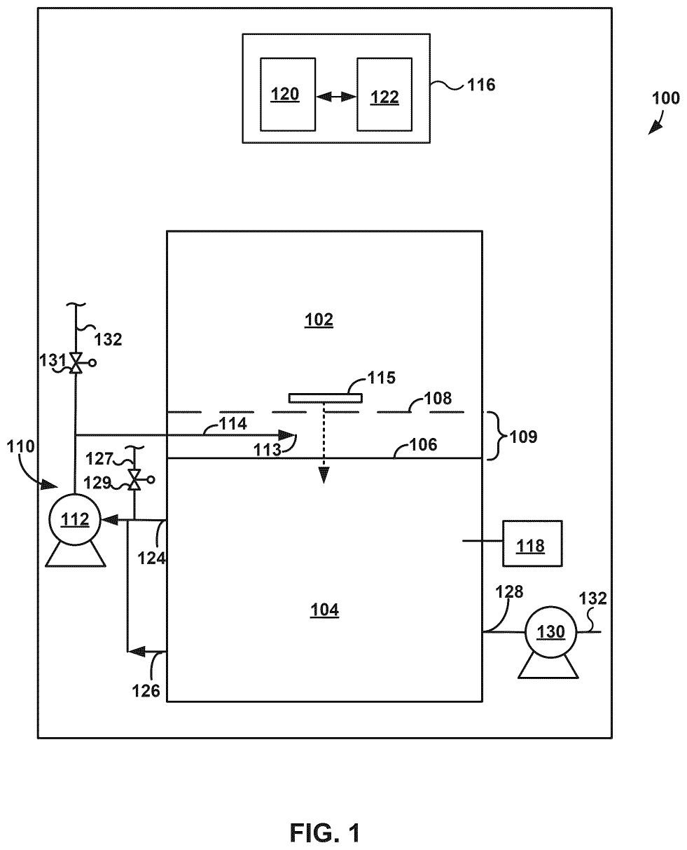

FIG. 1 is a conceptual diagram illustrating an example system 100 for dissolving solid chemical. System 100 includes a solid chemical reservoir 102, a solution reservoir 104, and a liquid blocking wall 106. Solid chemical reservoir 102 is illustrated as including a product support surface 108 on which solid chemical introduced into the reservoir can reside. Liquid blocking wall 106 is positioned between product support surface 108 and an interior of solution reservoir 104 to define a liquid filling space 109 between the liquid blocking wall and the product support surface. System 100 can also include a recirculation circuit 110 that includes a recirculation pump 112 and a recirculation line 114 for recirculating diluent introduced into the solution reservoir to form a solution. In the illustrated example, system 100 also includes a controller 116 that can manage the overall operation of the system. One or more sensors 118 can provide feedback concerning a liquid level inside of solution reservoir 104 and/or one or more characteristics of the solution being formulated using system 100.

Controller 116 can be communicatively connected to controllable components of system 100 (e.g., valves, pumps, sensors) and may send data and/or control signals to the components and/or receive data generated by the components during operation. Controller 116 can communicate with the various components via wired and/or wireless connections. Controller 116 includes processor 120 and memory 122. Memory 122 stores software for running controller 116 and may also store data generated or received by processor 120. Processor 120 runs software stored in memory 122 to manage the operation of system 100.

In operation, a user can introduce solid chemical to be dissolved into solid chemical reservoir 102. Solid chemical reservoir 102 may be sized to hold an amount of solid chemical suitable for forming multiple batches of solution. For example, solid chemical reservoir 102 may be filled periodically and multiple batches of solution generated without needing to refill the solid chemical reservoir before each batch. Alternatively, solid chemical reservoir 102 may be filled before each batch of solution generated using system 100.

In either case, controller 116 can control system 100 to introduce diluent into solution reservoir 104. The diluent may be added through a diluent opening 124 in fluid communication with solution reservoir 104.

Operating under the control of controller 116, recirculation circuit 110 can pump the diluent introduced into solution generator reservoir 104 to form a solution having a target concentration of dissolved chemical. For example, controller 116 may control system 100 (e.g., by controlling one or more valves and/or pumps controlling fluid communication between a diluent source and solution reservoir 104), to introduce a set volume of diluent into solution reservoir 104. The set volume of diluent introduced into solution reservoir 104 can correspond to a volume of solution desired to be formed for a particular batch. For example, the volume of diluent introduced into solution reservoir 104 may correspond to an amount of solution needed to be dispensed to a downstream application.

After introducing the desired amount of diluent into solution reservoir 104, controller 116 may control system 100 to cease delivering fresh diluent to the solution reservoir. Thereafter (or, concurrent with the introduction of diluent into the solution reservoir), controller 116 can control recirculation circuit 110 to recirculate the contents of solution reservoir 104. Recirculation pump 112 can withdraw the contents of solution reservoir 104 via an opening 126, pressurize the withdrawn liquid, and discharge the pressured fluid via an outlet 113 of a recirculation line 114 into liquid filling space 109.

Product support surface 108 bounding a lowermost extend of solid product reservoir 102 can have a plurality of apertures. The apertures may or may not be sized smaller than the solid chemical introduced the reservoir. In some examples, the apertures have a diameter within a range from 2 mm to 25 mm, such as from 5 mm to 15 mm. In some examples, solid product reservoir 102 has one or more of apertures sized larger than the solid chemical introduced the reservoir and an intermediate covering layer (e.g., mesh screen having smaller sized apertures is positioned between the solid chemical and larger aperture(s)). In either case, the apertures can extend through the thickness of product support surface 108 and can allow diluent to flow therethrough. During operation, liquid discharging from outlet 113 of recirculation line 114 can fill liquid filling space 109. As the liquid rises in liquid filling space 109, the liquid can rise through the apertures of product support surface 108, contacting and wetting the solid chemical on and/or at least partially above the product support surface. This can cause at least a portion of the solid product contacted by the liquid to dissolve and enter the liquid, increasing the concentration of one or more chemical agents present in the solid product in the liquid being recirculated through the system.

Solid chemical reservoir 102 can include one or more liquid outlet openings 115 positioned offset (e.g., vertically above) product support surface 108. Liquid discharging from outlet 113 of recirculation line 114 can fill liquid filling space 109 and rise to liquid outlet opening 115 before discharging from the liquid outlet opening and returning to solution reservoir 104. The distance between the top surface of product support surface 108 and liquid outlet opening 115 can correspond to the amount (e.g., depth/height) of solid product residing on the surface that is wetting during a generation event. As the diluent contacts and/or flows through the solid chemical on product support surface 108, the solid chemical may erode or otherwise dissolve and enter the diluent, thereby forming a solution containing dissolved chemical that then exits solid chemical reservoir 102 via liquid outlet opening 115 to return to solution reservoir 104.

In alternative configurations, outlet 113 of recirculation line 114 can be positioned above product support surface 108 (e.g., extending through a sidewall of solid product reservoir 102). In these configurations, liquid discharging from outlet 113 of recirculation line 114 can contact solid product residing on product support surface 108. The liquid can flow downwardly through the apertures of product support surface 108 into liquid filling space 109 positioned between product support surface 108 and liquid blocking wall 106 before discharging through liquid outlet opening 115 back into solution reservoir 104.

In any configuration, controller 116 can control recirculation circuit 110 to recirculate the contents of solution reservoir 104 until the solution has a target concentration of the solid chemical being dissolved in the solution. Sensor 118 may generate information indicative of the concentration of one or more chemical agents forming the solid chemical in the solution being formed to enable controller 116 to determine when to terminate recirculation action. Additionally or alternatively, controller 116 may control recirculation circuit 110 to recirculate the contents of solution reservoir 104 for a set amount of time (e.g., stored in memory 122) corresponding to the solution having target concentration of one or more chemical agents forming the solid chemical in the solution.

Upon reaching a target concentration and/or the set time, controller 116 can control recirculation circuit 110 to cease recirculating the liquid from solution reservoir 104 to liquid filling space 109. Controller 116 can control pump 112 to cease pumping and/or control an electronically controllable valve to selectively open or close fluid communication within the circuit.

In some configurations, such as that schematically illustrated in FIG. 1, solution reservoir 104 is located at a vertically lower elevation with respect to ground then solid chemical reservoir 102. As a result, solution generated can flow back to solution reservoir 104 under a force of gravity without providing a separate motive force to transport between the solid chemical reservoir 102 and solution reservoir 104. That being said, in other examples, system 100 may include a pump that is operable to transfer generated solution from solid chemical reservoir 102 (and/or an intermediate collection reservoir) and solution reservoir 104.

Solution generated in solution reservoir 104 can be retained in the solution reservoir for any suitable amount of time. Solution can be withdrawn from solution reservoir 104 as needed for use. Solution reservoir 104 may include an outlet 128 through which solution retained in the reservoir is discharged. In some examples, system 100 includes a delivery pump 130 that is in fluid communication with solution reservoir 104 via outlet 128, pressurizes the solution, and discharges the solution via a discharge conduit 132. System 100 may include a separate delivery pump 130 from recirculation pump 112 for controlling delivery of solution from solution reservoir 104, as illustrated in FIG. 1. Alternatively, system 100 may utilize the same pump 112 for performing both recirculation and downstream delivery. In these alternative configurations, an appropriate network of fluid conduits and/or valves may be provided to allow the pump to selectively operate in recirculation mode or discharge mode. For example, system 100 may include discharge conduit 132 fluidly connected to recirculation pump 112 via a metering valve 131. Controller 116 can control metering valve 131 to open and close the valve and/or to adjust the volume of fluid flowing through the valve (based on the amount the metering valve is opened) to deliver a controlled volume and/or pressure of fluid to a downstream location. Although not illustrated, one or more other valves may be included in recirculation circuit 110 to close liquid discharge through outlet 113 when using recirculation pump 112 to deliver liquid to discharge conduit 132.

When configured with a separate recirculation pump 112 and delivery pump 130, the pumps may be selected to optimize the operating requirements of their respective tasks. For instance, in some examples, delivery pump 130 may be configured to operate at a higher pressure and lower volume than recirculation pump 112. That is, recirculation pump may operate to draw a higher volume of fluid from solution reservoir 104 for recirculation then the volume of fluid withdrawn and delivered by delivery pump 130. However, the pressure at which recirculation pump 112 discharges fluid may be less than the pressure at which delivery pump 130 discharges fluid. This arrangement may be useful to provide a high recirculation flow rate by recirculation pump for dissolving solid chemical in solid chemical reservoir 102. The comparatively lower delivery rate of delivery pump 130 may be useful to avoid delivering a large bolus of corrosive chemistry to a downstream location (which may cause corrosion issues), instead delivering a comparatively smaller amount of the chemistry to the downstream location, which may mix with additional water at that location.

During operation, controller 116 may receive a dispense request requesting preparation of a requested amount of a solution. The dispense request may be received in response to a user input, in response to information from a sensor indicating that additional solution is needed, and/or other information indicating that preparation of additional solution is required. The dispense request may specify a requested amount (e.g., volume or weight) of solution to be prepared, a requested concentration of a solid chemical to be dissolved in the solution to be prepared, and/or a requested compositional formulation for the solution to be prepared. From this information, controller 116 may determine a target amount of diluent to introduce into solution reservoir 104 and/or a target amount of solid chemical to be dissolved to achieve the target concentration requested. In some examples, controller 116 references formulation information stored in memory 122 associated with the controller to determine a target amount of diluent and/or solid needed to prepare the requested solution. The formulation information may be stored in the form of look-up tables, equations, ratios, or any other suitable form. Controller 116 can then control system 100 to prepare the requested solution based on the received and/or determined information.

For example, as discussed above, controller 116 can control system 100 to introduce the target amount of diluent into solution reservoir 104. Controller 116 may receive information from a sensor indicative of the amount of diluent added to solution reservoir 104 (e.g., volume/flow sensor, weight sensor, level sensor) to control addition of the diluent to achieve the target. After or concurrent with introducing the diluent into solution reservoir 104, controller 116 can control recirculation circuit 110 to recirculate the contents of solution reservoir 104 until the solution has a target concentration of the solid chemical (e.g., chemical agents forming the solid chemical which enter the liquid solution upon being dissolved) in solid chemical reservoir 102 dissolved in the solution. Sensor 118 can generate information indicative of the concentration of the solid chemical in the solution being formed to enable controller 116 to determine when to terminate recirculation action. In different examples, sensor 118 may be implemented as a conductivity sensor that measures the conductivity of solution being formulated in solution generator reservoir 104, an optical sensor that measures the optical characteristics of the solution being formulated in solution generator reservoir 104, or a weight and/or volume sensor that measures the weight and/or volume of the contents in solution reservoir 104. For example, sensor 118 may be or include a mechanical volume sensor (e.g., float sensor) and/or ultrasonic float sensor to measure a volume of the contents in solution reservoir 104.

In any configuration, sensor 118 can measure a characteristic indicative of the amount of solid chemical that has eroded and entered the solution being generated, thereby providing a measure of the concentration of the solid chemical dissolved in the diluent. Controller 116 may control recirculation circuit 110 to terminate recirculation when information from sensor 118 indicates that the concentration of the solid chemical dissolved in the diluent has reached the target concentration.

In addition to or in lieu of relying on information from sensor 118, controller 116 may control recirculation circuit 110 to recirculate the contents of solution reservoir 104 for a set amount of time (e.g., from 10 minutes to 2 hours, such as from 15 minutes to 1 hour). The set amount of time can be determined empirically (and stored in a memory associated with the controller) as corresponding to a target concentration of the solid chemical dissolved in the diluent. Controller 116 may control recirculation circuit 110 to terminate recirculation at the set amount of time.

Independent of the specific amount and composition requested in a dispense request, controller 116 may receive a dispense request entered by a user and/or electronically stored in a memory. For example, a user may enter a dispense request specifying the amount of solution to be prepared and the concentration of the requested solution. As another example, controller 116 may store a programmed sequence of dispense requests to be prepared at certain times of day or in a predefined sequence. As another example, a dispense request may be automatically generated when it is determined that more solution is needed. For example, if solution is being drawn out of solution reservoir 104 on an as-needed basis, an out-of-product sensor may detect when the reservoir is below a threshold (e.g., empty or nearing empty). The out-of-product sensor may then automatically generate a dispense request. Similarly, if solution reservoir 104 is drawn in known quantities, a dispense request may be automatically generated after a certain number of draws known to empty the reservoir have occurred.

Controller 116 may also store one or more settings corresponding to preparations of multiple solutions, where each solution has a different formulation than each other solution. For example, settings required to prepare solutions of different volumes/concentrations/compositions may be stored for one or more chemical products including detergent, sanitizer, rinse agent, bleach, disinfectant, etc. Also, multiple different target concentrations may be stored for each agent depending upon the target solution being formulated. For example, cooling water biocides of different concentration may be required depending on the type and/or extent of biological contaminants in the cooling water.

Controller 116 may perform other control and monitoring functions within system 100, e.g., to generate a dispense request to initiate preparation of a given amount of solution having a target concentration of the solid chemical being dissolved. As one example, controller 116 may initiate a timer upon preparing a solution that counts the amount of time elapsed since the solution was prepared. With reference to time limits stored in memory, controller 116 may provide a user alert when the elapsed time has exceeded a threshold amount of time. In some examples, controller 116 controls system 100 to discharge and discard the contents of solution reservoir 104 when the elapsed time has exceeded the threshold amount of time. Accordingly, for these configurations, system 100 may be in selective fluid communication with a drain where the contents of solution reservoir 104 can be discarded. In some such examples, controller 116 may also automatically generate a fresh batch of solution in solution reservoir 104 after discarding the prior batch. Different time limits may be stored in memory for different dilute chemical solutions. Example time limits may be, but are not limited to, 2 hours, 4 hours, 8 hours, 12 hours, 1 day, and 1 week, such as a time period ranging from 6 hours to 48 hours, or from 12 hours to 36 hours. Discarding old solution on a periodic basis may be helpful, e.g., to prevent bacterial growth in a solution and to ensure that desired chemistries in the solution are active, among other reasons.

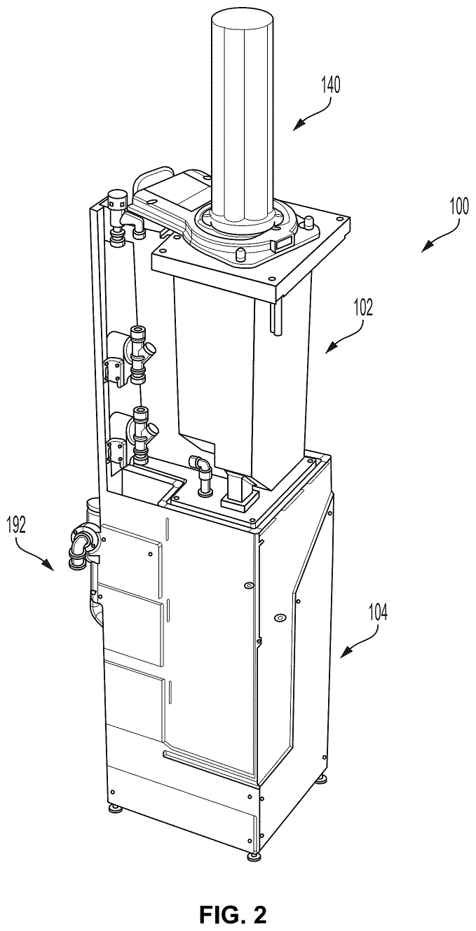

System 100 can have a variety of different configurations and arrangements, as discussed in greater detail with respect to FIGS. 2-5. In general, however, system 100 may be used to dissolve any desired type of solid chemical for a dilute liquid solution. Example solid chemicals that may be stored and dispensed using solid chemical reservoir 102 include, but are not limited to, an oxidizing biocide, a non-oxidizing biocide, a sanitizer, a sterilant, a cleaner, a degreaser, a lubricant, a detergent, a stain remover, a rinse agent, an enzyme, and the like. The solid chemical may be reactive with or inert to the diluent introducing into solution reservoir 104. While the concentrated chemical introduced into solid chemical reservoir 102 is generally described herein as being in a completely solid state, in other applications, a pseudo-solid/liquid form, such as a gel or paste may be introduced into solid chemical reservoir 102.

In applications where the chemical is in a solid form, the solid chemical may be formed by casting, extruding, molding, and/or pressing. The solid chemical filling reservoir 102 may be structured as one or more blocks of solid chemical, a powder, a flake, a granular solid, or other suitable form of solid. Examples of solid product suitable for use in reservoir 102 are described, for example, in U.S. Pat. Nos. 4,595,520, 4,680,134, U.S. Reissue Patent Nos. 32,763 and 32,818, U.S. Pat. Nos. 5,316,688, 6,177,392, and 8,889,048.

The diluent introduced into dissolved chemical reservoir is typically water (e.g., deionized water), although other liquid compounds that are desired to form a majority percentage of a dilute chemical solution can be used instead of water. When water is used as a diluent, the water may be delivered directly from a pressurized water main, for example without utilizing a diluent pump, by controlling a valve providing selective fluid communication. Additionally or alternatively, system 100 may include a diluent pump in fluid communication with a source of diluent to control addition of the diluent to solution reservoir 104. The example system of FIG. 1 illustrates a water line 127 in selective communication with opening 124 via a valve 129. Valve 129 can be communicatively coupled to controller 116, which can control addition of water to solution generator reservoir 104 by at least controlling valve 129.

Pumps 112 and 130 may each be any form of pumping mechanism that supplies fluid. For example, pumps 112 and 130 may comprise a peristaltic pump or other form of continuous pump, a positive-displacement pump, a centrifugal pump, or any other type of pump appropriate for the particular application. Components described as valves (129) may be any device that regulates the flow of a fluid by opening or closing fluid communication through a fluid conduit. In various examples, a valve may be a diaphragm valve, ball valve, check valve, gate valve, slide valve, piston valve, rotary valve, shuttle valve, and/or combinations thereof. Each valve may include an actuator, such as a pneumatic actuator, electrical actuator, hydraulic actuator, or the like. For example, each valve may include a solenoid, piezoelectric element, or similar feature to convent electrical energy received from controller 116 into mechanical energy to mechanically open and close the valve. Each valve may include a limit switch, proximity sensor, or other electromechanical device to provide confirmation that the valve is in an open or closed position, the signals of which are transmitted back to controller 116. Fluid conduits and fluid lines in system 100 may be pipes or segments of tubing that allow fluid to be conveyed from one location to another location in the system. The material used to fabricate the conduits should be chemically compatible with the liquid to be conveyed and, in various examples, may be steel, stainless steel, or a polymer (e.g., polypropylene, polyethylene).

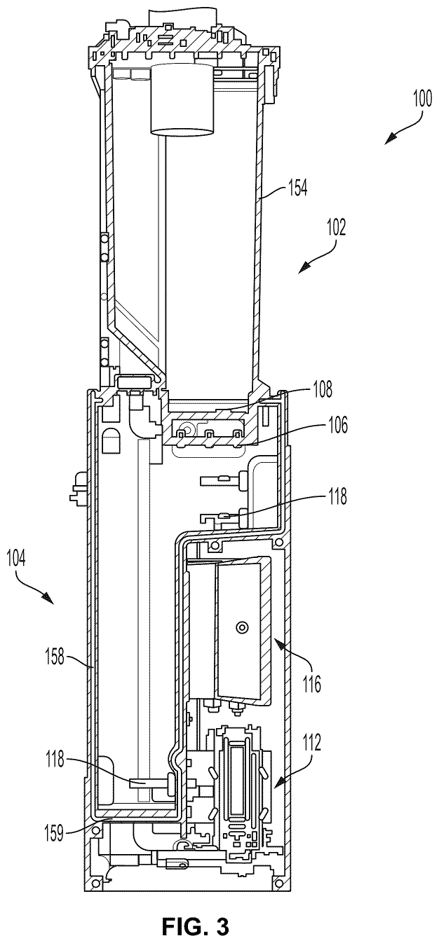

FIG. 2 is a perspective of an example configuration of system 100 from FIG. 1, and FIG. 3 is a side sectional view of an example configuration of system 100 from FIG. 1. Like reference numerals in FIGS. 2 and 3 refer to like features discussed above with respect to FIG. 1. As shown in the example of FIGS. 2 and 3, system 100 includes previously-described solid chemical reservoir 102 and solution reservoir 104. In this example, solid chemical reservoir 102 is vertically arranged and aligned with solution reservoir 104. Solid chemical reservoir 102 may be positioned fully above solution reservoir 104 or may extend partially inside of solution reservoir 104.

In general, solid chemical reservoir 102 may be any structure configured to contain solid chemical for dissolution within solution reservoir 104, while solution reservoir 104 may be any structure configured to receive and contain diluent to be recirculated to contact solid chemical to form a solution during use and/or to hold a formed solution prior to use. Solid chemical reservoir 102 may be formed by at least one sidewall 154 (FIG. 3) extending vertically upwardly and product support surface 108 joining the sidewall. Solution reservoir 104 may also be formed by at least one sidewall 158 extending vertically upwardly and a bottom wall 159 joining the sidewall. The number of sidewalls interconnected together to form the side structure of each reservoir may vary depending on the shape of the reservoir. For example, a reservoir with a circular cross-sectional shape may be formed of a single sidewall whereas a reservoir with a square or rectangular cross-sectional shape may be defined by four interconnected sidewalls.

In general, solid chemical reservoir 102 and solution reservoir 104 can each define any polygonal (e.g., square, hexagonal) or arcuate (e.g., circular, elliptical) shape, or even combinations of polygonal and arcuate shapes. In the example of FIGS. 2 and 3, however, solid chemical reservoir 102 and solution reservoir 104 are each illustrated as having a generally rectangular shape. Each reservoir can be fabricated from a material that is chemically compatible with and chemically resistant to the type of solid chemical and/or solution to be present in the reservoir. In some examples, each reservoir is fabricated from a polymeric material, such as a molded plastic.

In some examples, the top end of solid chemical reservoir 102 may be completely closed by a top wall. The top wall may be removable or include an openable section to facilitate introduction of solid chemical into solid chemical reservoir 102. For example, as shown in FIG. 2, system 100 may include a chemical dispensing docking station 140 positioned on a top surface of solid chemical reservoir 102. Chemical dispensing docking station 140 may be configured to engage an exterior container of solid chemical and include a movable element which, when opened, allows solid chemical to transfer from the external container into solid chemical reservoir 102. Additional details on an example docking station that can be used are described in a U.S. Pat. No. 11,401,084, entitled “PACKAGING AND DOCKING SYSTEM FOR NON-CONTACT CHEMICAL DISPENSING,” issued Aug. 2, 2022, the entire contents of which are incorporated herein by reference. In other examples, the top end of solid chemical reservoir 102 may be partially or fully open.

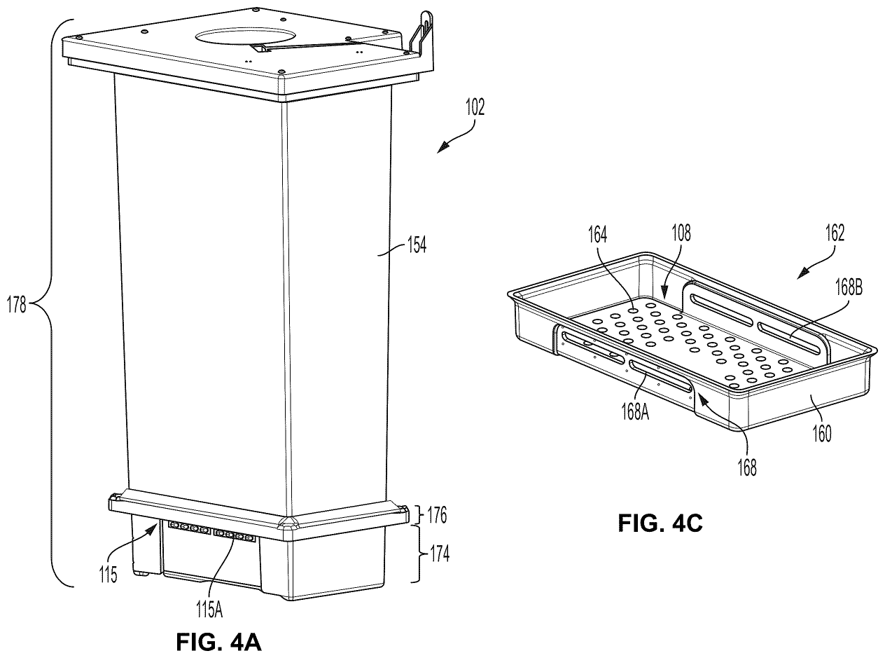

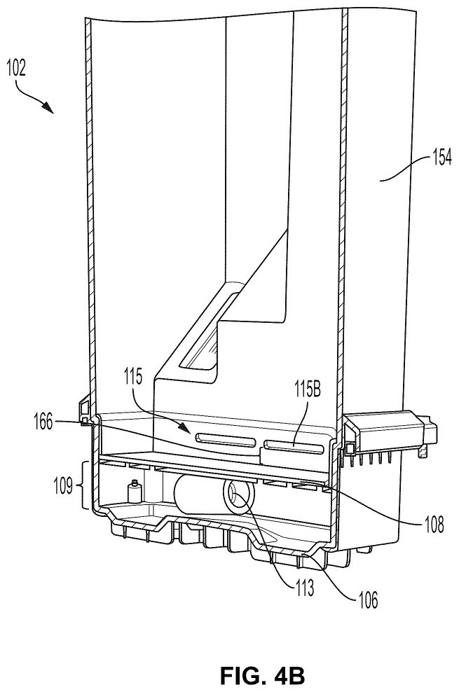

As briefly discussed above with respect to FIG. 1, system 100 may include a liquid blocking wall 106 positioned between the product support surface 108 of solid chemical reservoir 102 and an interior of solution reservoir 104. This can define a liquid filling space 109 between the liquid blocking wall and the product support surface into which recirculating diluent can be discharged. FIG. 4A is a perspective view of an example configuration of solid chemical reservoir 102 isolated from surrounding features of system 100; FIG. 4B is a side sectional view of a portion of solid chemical reservoir 102 showing an example arrangement of features; FIG. 4C is a perspective view of an example insert that can be inserted into solid chemical reservoir 102 to provide product support surface 108 on which solid chemical resides during use. FIGS. 4A-4C are collectively referred to as “FIG. 4” below.

As shown in FIG. 4, solid chemical reservoir 102 includes product support surface 108, which can be a surface extending across the cross-sectional area of solid chemical reservoir 102 that can receive and support solid chemical thereon. Solid chemical reservoir 102 also includes at least one sidewall 154 extending vertically upwardly from product support surface 108. Product support surface 108 may be integrally joined with and/or permanently formed with sidewall 154 to provide a monolithic structure or, in other examples, product support surface 108 may be separable from sidewall 154 and operably connectable thereto.

For example, as shown in FIG. 4C, product support surface 108 may be connected to at least one upwardly extending sidewall 160 to define solid product support basket 162. Product support basket 162 can have any of the shapes and configurations discussed above as being suitable for solid chemical reservoir 102 and may typically have the same shape as the solid chemical reservoir. Product support basket 162 can be inserted into an interior of solid chemical reservoir 102. Product support basket 162 may engage one or more connection features inside of solid chemical reservoir 102 and/or an interior surface of sidewall 154 to be retained at a target elevation within the solid chemical reservoir. In some examples, solid chemical reservoir 102 may taper or reduce in cross-sectional area moving from a top end of the reservoir to a bottom end of the reservoir. Product support basket 162 may have a cross-sectional area smaller than the cross-sectional area of the top end of solid chemical reservoir 102 but larger than the cross-sectional area of the bottom end of the solid chemical reservoir. Accordingly, product support basket 162 may frictionally engage sidewall 154 of solid chemical reservoir 102 at a location inside of the solid chemical reservoir 102 where the internal cross-sectional area of the reservoir narrows to a size less than the size of the product support basket. An internal ledge and/or other engagement feature(s) may also be provided.

Product support surface 108 can include a plurality of apertures 164 (FIG. 4C) extending through the thickness of the surface. The apertures may be sized effective to allow liquid filling into liquid filling space 109 (FIG. 1) to flow upwardly through the apertures and contact solid product residing on the surface of the support plate. At the same time, the apertures may be sized smaller than the solid chemical intended to be used with system 100, which may vary depending on whether the system is intended to be large pucks, comparatively small granules, or different sized media. In some examples, apertures 164 have a diameter within a range from 2 mm to 25 mm, such as from 5 mm to 15 mm. The apertures may be substantially uniformly arrayed across product support surface 108 (e.g., to provide substantially even liquid distribution) or may be asymmetrically arranged across the product support surface.

With further reference to FIG. 4, particularly FIGS. 4A and 4B, solid chemical reservoir 102 is illustrated as including at least one sidewall 154 extending vertically upwardly from product support surface 108 and at least one liquid outlet opening 115 extending through the at least one sidewall. Liquid outlet opening 115 is offset from product support surface 108 (by being vertically elevated above the product support surface). Liquid outlet opening 115 extends through the thickness of sidewall 154 and can communicate liquid flow from an interior of the reservoir to solution reservoir 104 (FIG. 1). A distance 166 between the top surface of product support surface 108 and a bottom-most edge of liquid outlet opening 115 may be controlled to help limit the height liquid rises above product support surface 108 during operation and, correspondingly, the amount of solid product wetted. This can help reduce residual offgassing from the wetted product after a generation cycle. In some implementations, distance 166 is comparatively small, such as less than 225 mm, such as less than 150 mm, less than 100 mm, less than 75 mm, less than 50 mm, or less than 25 mm. The height of the solid product wetted during use of system 100 can correspond to any one of these foregoing limits. In one example, distance 166 (and the height of solid product wetted) is within a range from 35 mm to 75 mm, which may wet an amount of solid product suitable to efficiently generate a use solution while minimizing residual offgassing.

In addition to or in lieu of controlling the distance 166 to limit the amount of solid product wetted during operation of system 100, the total volume of solid product wetted may be controlled. The total volume of solid product wetted may be a function of the area of product support surface 108 (determined by multiplying the length of the surface by the width of the surface) and the distance 166 between the top surface of product support surface 108 and liquid outlet opening 115. This total volume of solid product wetted can be controlled by controlling the ratio of an area of product support surface 108 divided by the distance 166 liquid outlet opening 115 is offset from the product support surface. The ratio may be sufficiently large to ensure enough solid product is wetted to efficiently generate a dilute chemical solution but not so large to leave an excessive amount of wetted product after a generation cycle. In some implementations, the system is sized to provide a ratio within a range from 1000 to 3500, such as from 1250 to 3000, or from 1600 to 2600.

The at least one liquid outlet opening 115 can be positioned so liquid discharging through the outlet flows back into solution reservoir 104. The number, size, and configuration of liquid outlet openings can vary. In some configurations, solid chemical reservoir 102 includes only a single liquid outlet opening. In other configurations, solid chemical reservoir 102 may include multiple liquid outlet openings. For example, solid chemical reservoir 102 may include at least two liquid outlet openings 115A (FIG. 4A) and 115B (FIG. 4B) extending through the at least one sidewall 154 on substantially opposite sides of the solid chemical reservoir. This arranged can help with provide a substantially uniform liquid flow through the solid material on product support surface 108 and out of solid chemical reservoir 102. The combined area of the one or liquid outlet openings 115 may be sized relative to the flow rate of recirculation pump 112, e.g., such that the volume of liquid introduced into solid chemical reservoir 102 via operation of the pump is less than the discharge capacity of the one or liquid outlet openings to prevent excess liquid buildup inside of the chemical reservoir.

When product support surface 108 is defined by a product support basket 162 having at least one upwardly extending sidewall 160 (FIG. 4C), the product support basket can have at least one opening 168 aligned with the at least one liquid outlet opening 115 of solid product reservoir. For example, the product support basket 162 can have at least two openings 168A, 168B aligned with liquid outlet openings 115A and 115B extending through substantially opposite sides of the solid chemical reservoir. When product support basket 162 is positioned inside of solid chemical reservoir 102, the one or more openings 168 are aligned with the one or more openings of the solid chemical reservoir, e.g., such that liquid can flow through the opening(s) 168 and corresponding aligned opening(s) 115 to discharge out of the solid product reservoir.

With further reference to FIGS. 2 and 4B, system 100 includes a liquid blocking wall 106. Liquid blocking wall 106 is positioned between product support surface 108 of solid chemical reservoir 102 and an interior of solution reservoir 104 to define liquid filling space 109 between the liquid blocking wall and the product support surface of the solid chemical reservoir. In different implementations, liquid blocking wall 106 may be formed as part of and/or connected to solid chemical reservoir 102, be formed as part of and/or connected to solution reservoir 104, and/or may be an intermediate structure positioned between the two reservoirs. For example, as illustrated in FIG. 4B, liquid blocking wall 106 may be connected to the at least one sidewall 154 of solid chemical reservoir 102. When so configured, liquid blocking wall 106 can form a bottom surface of solid chemical reservoir 102 (e.g., integrally joined with sidewall 154). In other examples, liquid blocking wall 106 can form a top surface of solution reservoir 104 (e.g., integrally joined with sidewall 158 defining the solution reservoir). In yet other examples, liquid blocking wall 106 may be a component inserted between solid chemical reservoir 102 and solution reservoir 104 without being formed as part of and/or integrally joined with sidewall 154 or sidewall 158 defining the body of either respective reservoir.

In general, liquid blocking wall 106 may be positioned between product support surface 108 and bottom wall 159 of solution reservoir 104 to define liquid filling space 109 between the liquid blocking wall in the product support surface. Liquid blocking wall 106 can separate product support surface from an interior of solution reservoir 104 (e.g., the interior space of the reservoir between the bottom of the liquid blocking wall and bottom wall 159 founding solution reservoir 104). In different examples, liquid blocking wall 106 may be positioned within solid chemical reservoir 102 (above the bottom most edge of sidewall 154), within solution reservoir 104 (below the top most edge of sidewall 158), and/or directly in between solid chemical reservoir 102 and solution reservoir 104.

Liquid blocking wall 106 may function to block liquid pumped via recirculation pump 112 and discharged via an outlet 113 from flowing back down into solution reservoir 104 rather than rising upwardly through the apertures in product support surface 108 to contact solid product thereon. Liquid blocking wall 106 can extend partially or entirely across the cross-sectional area (width and length) of solid chemical reservoir 102 and/or solution reservoir 104. In some configurations, liquid blocking wall 106 is solid (e.g., devoid of openings) such that liquid cannot flow through the liquid blocking wall. When so configured, the liquid blocking wall may or may not form a fluid tight seal with the interior surface of solid product reservoir 102 and/or solution reservoir 104 to allow or prevent liquid from flowing around one or more sides of the liquid blocking wall.

In other examples, liquid blocking wall 106 may include one or more apertures extending through the thickness of the liquid blocking wall. The apertures may be configured (e.g., sized and/or shaped) to allow liquid to drain through the liquid blocking wall after liquid delivery by recirculation pump 112 is terminated. For example, the apertures may be in the form of weep holes that allow liquid to drain through the liquid blocking wall after a generation cycle is complete rather than allowing a stagnant pool of liquid to be retained in liquid filling space 109. The apertures may be sized smaller than apertures 164 extending through the thickness of product support surface 108. The apertures may be sized effective such that, when liquid is recirculating and discharging out of outlet 113, a majority of the liquid flows upwardly through the apertures in product support surface 108 rather than downwardly through the apertures in the liquid blocking wall, such as at least 60 volume percent of the liquid flow, at least 70 volume percent of liquid volume flow, at least 80 volume percent of liquid volume flow, at least 90 volume percent of liquid volume flow, at least 95 volume percent of the liquid volume flow, or at least 98 volume percent of the liquid volume flow. In some examples, the apertures formed through liquid blocking wall 106 have a diameter less than 10 mm, such as less than 5 mm, or less than 2 mm.

Liquid filling space 109 may be a comparatively small region of system 100 that outlet 113 of recirculation circuit 110 discharges liquid being recirculated into. In some examples, liquid filling space 109 may have a height measured from the bottom of product support surface 108 to the top of liquid blocking wall 106 less than 25 cm, such as less than 20 cm, less than 15 cm, or less than 10 centimeters. Configuring system 100 so outlet 113 of recirculation circuit 110 discharges into the liquid filling space rather than directly onto product support surface 108 may promote more uniform dissolution of solid product (e.g., by allowing liquid to rise upwardly across the entire cross-sectional area of the product support surface) and/or may reduce or eliminate excessive wetting of solid product to minimize residual offgassing.

Solid chemical reservoir 102 and solution reservoir 104 can have a variety of different configurations and arrangements relative to each other. In some implementations, solid chemical reservoir 102 and solution reservoir 104 are formed by dividing a single vessel into multiple different regions. In other examples, different vessels forming solid chemical reservoir 102 and solution reservoir 104, respectively, may be fabricated and operatively coupled together.

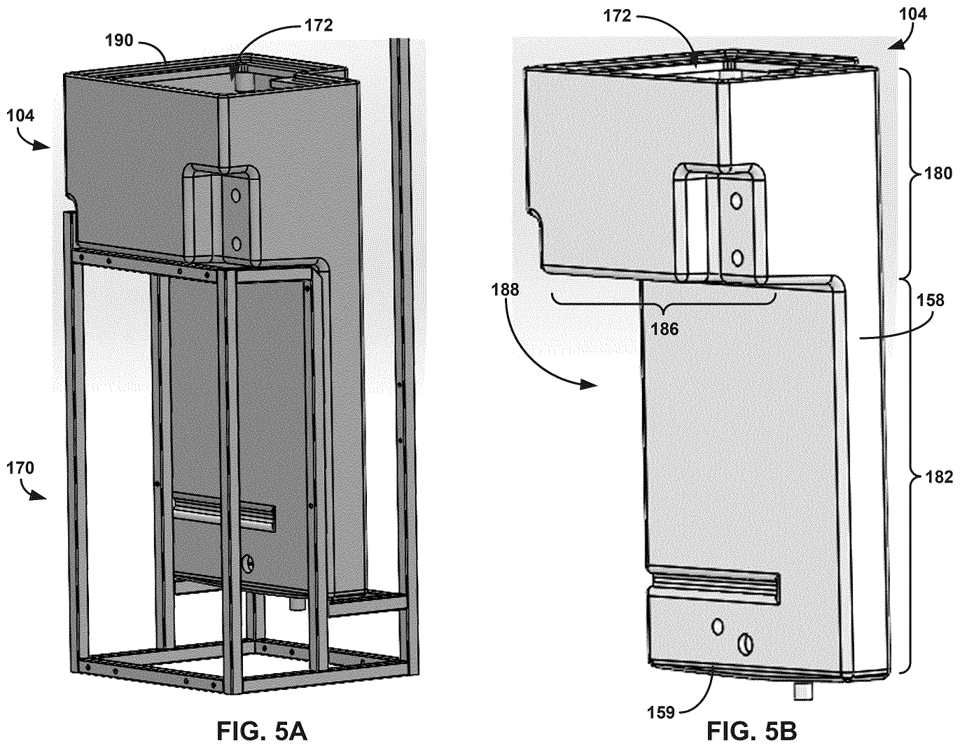

FIGS. 5A and 5B (collectively referred to as “FIG. 5”) are different perspective views of an example configuration of solution reservoir 104. FIG. 5A illustrates solution reservoir 104 engaged with an example support frame 170. FIG. 5B illustrates solution reservoir 104 separated from the example support frame. As shown in the example of FIG. 5, solution reservoir 104 has a body extending from an open top end 172 to a closed bottom end defined by bottom wall 159. Solid chemical reservoir 102 can be axially aligned with the open top end 172 of the solution reservoir.

In some examples, solid chemical reservoir 102 is aligned with and inserted partially but not fully into the open top end 172 of the solution reservoir. For example, FIG. 3 illustrates solid chemical reservoir 102 inserted partially but not fully into the open top end 172 of the solution reservoir. Solid chemical reservoir 102 may be inserted a distance down into solution reservoir 104 sufficient to position the one or more liquid outlet openings 115 extending through the sidewall of the solid chemical reservoir below the top most edge of the solid chemical reservoir. As a result, as liquid flows out of the one or more liquid outlet openings 115, the liquid to flow directly down into the solution reservoir.

To allow solid chemical reservoir 102 to be inserted partially but not fully into solution reservoir 104, the solid chemical reservoir can have a region with a cross-sectional area sized smaller than the cross-sectional area of at least a portion of solution reservoir 104. With reference to FIG. 4A, for example, solid chemical reservoir 102 may define a first lengthwise portion 174 having a cross-sectional area (length×width) sized smaller than cross-sectional area (length×width) defined by the open top end 172 of the solution reservoir 104. Solid chemical reservoir 102 can have a second lengthwise portion 176 having a cross-sectional area sized larger than the cross-sectional area defined by the open top end 172 of the solution reservoir, thereby limited the depth to which the solid chemical reservoir is inserted into the solution reservoir. The size of the first lengthwise portion 174 inserted into solution reservoir 104 may be comparatively small, e.g., to limit direct or indirect wetting of solid product in the reservoir to minimize residual offgassing. For example, the size of the first lengthwise portion 174 may be less than 25% of the overall length 178 of solid chemical reservoir 102, such as less than 20% of the overall length of the solid chemical reservoir, less than 15% of the overall length of the solid chemical reservoir, or less than 10% of overall length of the solid chemical reservoir.

Solution reservoir 104 can have a variety of different sizes and configurations. In some examples, solution reservoir 104 is asymmetrically sized (e.g., such that one region of the reservoir has a different cross-sectional size than a different region of the reservoir). This can create a recessed region or pocket that can house components of system 100 without expanding the footprint of the system. For example, solution reservoir 104 may have an upper region that has a larger cross-sectional area than an adjacent and connected lower region such that the upper region overhangs and bounds a pocket into which one or more components of system 100 can be positioned.

With reference to FIG. 5, solution reservoir 104 is illustrated as defining an upper section 180 having a first cross-sectional area (length×width) and a lower section 182 having a second cross-sectional area (length×width) less than the first cross-sectional area. The lower section 182 is aligned with a first portion 184 of upper section 180 and is offset from a second portion 186 of the upper section. In this example, lower section 182 is offset from a longitudinal centerline bisecting solution reservoir 104 longitudinally. Solution reservoir 104 defines a cavity 188 that second portion 186 of upper section 180 extends over. As a result, cavity 188 is bounded on one side by a lengthwise extent of lower section 182 and on a top side by a bottom wall bounding upper section 180. In some examples, the cross-sectional area of upper section 180 is at least 50% larger than the cross-sectional area of lower section 182, such as at least 100% larger, at least 150% larger, or at least 200% larger. In some examples, the length of lower section 182 is at least 25% longer than the length of upper section 180, such as at least 50% longer, at least 75% longer, at least 100% longer, or at least 150% longer.

Various components of system 100 can be located in cavity 188, such as illustrated on FIG. 3. For example, one or more pumps, valves, controllers, and/or other features of the system can be positioned within cavity 188, thereby retaining features without expanding the footprint of the overall system. In some examples, recirculation pump 112, delivery pump 130, one or more controllers 116, and/or other features of the system may be positioned within cavity 188.

System 100 can have a variety of additional features and configurations. In some implementations, system 100 includes one or more sealing features to help seal gas communication between an interior of the system (an interior of solid chemical reservoir 102 and/or an interior of solution reservoir 104) an exterior environment. In the event that noxious gas is generated due to wetting of the solid product being dissolved, such sealing features can limit the extent to which such gas exits system 100 and enters the ambient environment.

As one example, system 100 may include a sealing gasket 190 (FIG. 5A) at a junction between solution reservoir 104 and solid chemical reservoir 102. Such a sealing gasket can help seal the junction between the two components to prevent gas exchange at the junction. Additionally or alternatively, system 100 may include gas-sealed overflow port 192 (FIG. 2) in fluid communication with solution reservoir 104. The overflow port 192 may be a discharge opening located above an expected high-level operating location inside of solution reservoir 104 configured to discharge liquid from the solution reservoir in the event of unexpected overfilling. Overflow port 192 may include a liquid (e.g., water)-filled P-trap that acts as barrier to seal off gas communication through the overflow port, helping to prevent offgassing from escaping through the overflow port.

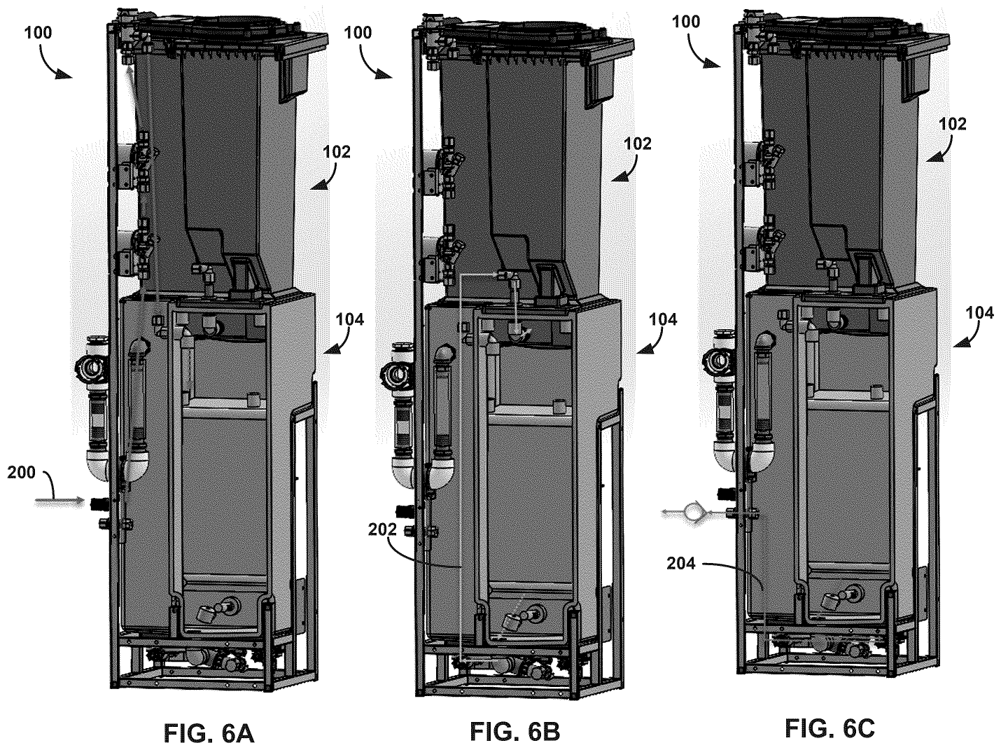

FIGS. 6A-6C are side views of system 100 showing different example liquid flows using the system during a generation cycle and subsequent discharge from the system. FIGS. 6A-6C will be described with reference to example features of system 100 discussed above. With reference to FIG. 6A, water 200 is received from a water line 127 (FIG. 1) in selective communication with an opening 124 to solution reservoir 104 via a valve 129. Valve 129 can be controlled by controller 116 to control addition of water to solution reservoir 104. System 100 may include one or more level sensors 118 (e.g., a low level sensor and a high level sensor). Controller 116 can control addition of water to solution reservoir 104 until a target water level is reached in solution reservoir 104 as indicted by measurement information from level sensor 118. The level to which water is filled in solution reservoir 104 can be vertically below the plane defined by liquid blocking wall 106.

With reference to FIG. 6B, liquid 202 is recirculated from solution reservoir 104 by drawing the liquid from the solution reservoir and discharging the liquid through outlet 113 of recirculation line 114 into liquid filling space 109 positioned between product support surface 108 on which solid chemical resides and liquid blocking wall 106. As liquid is increasingly pumped, the volume of liquid in liquid filling space 109 increases until the liquid flows upwardly through apertures 164 of product support surface 108. The liquid rising through apertures 164 contacts the solid chemical on the product support surface, resulting in at least partial dissolution of the solid chemical into the liquid and an increase in concentration of one or more chemical agents from the solid chemical in the liquid. The liquid with increased concentration of one or more chemical agents from the dissolved solid chemical then discharges through liquid outlet opening 115 and falls under a force of gravity back into solution reservoir 104. The liquid may be pumped via recirculation pump 112 multiple times from solution reservoir 104, to liquid filling space 109, up through product support plate 108, and out through liquid outlet opening 115. The liquid may be pumped a fixed amount of time and/or until information from a concentration sensor 118 (e.g., conductivity sensor) indicates that a target concentration of the dissolved solid chemical has been reached in the liquid, in either case providing a resultant generated chemical solution.

With reference to FIG. 6C, the generated chemical solution 204 is discharged from solution reservoir 104. In some examples, recirculation pump 112 is used to pressurize and discharge the generated chemical solution, e.g., via a metering valve 131 through discharge conduit 132. In some examples, a separate delivery pump 130 is used to pressurize and discharge the generated chemical solution through a discharge conduit.

A system for dissolving solid chemical according to disclosure can provide an efficient and compact arrangement that can generate consistent and accurate liquid chemical solutions from concentrated solid product with controlled offgassing.

The techniques described in this disclosure, including functions performed by a controller, control unit, or control system, may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, and firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for case of illustration, and does not necessarily require realization of such features by separate hardware, firmware, or software components. In some cases, various units may be implemented as programmable processes performed by one or more processors or controllers.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices.

If implemented in part by software, the techniques may be realized at least in part by a computer-readable data storage medium (e.g., a non-transitory computer-readable storage medium) comprising code with instructions that, when executed by one or more processors or controllers, performs one or more of the methods and functions described in this disclosure. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

Various examples have been described. These and other examples are within the scope of the following claims.

1. A system for dissolving solid chemical comprising:
(a) a solid chemical reservoir configured to receive a solid chemical to be dissolved, the solid chemical reservoir having:
(i) a product support surface having a plurality of apertures configured to allow diluent to flow therethrough;
(ii) at least one sidewall extending vertically upwardly from the product support surface; and
(iii) a liquid outlet opening extending through the at least one sidewall that is offset from the product support surface;
(b) a solution reservoir positioned vertically below the solid chemical reservoir with the liquid outlet opening of the solid chemical reservoir being in fluid communication with the solution reservoir;
(c) a liquid blocking wall positioned between the product support surface of the solid chemical reservoir and an interior of the solution reservoir to define a liquid filling space between the liquid blocking wall and the product support surface of the solid chemical reservoir; and
(d) a recirculation circuit that includes (i) a recirculation pump and (ii) a recirculation line having an outlet in the liquid filling space between the liquid blocking wall and the product support surface of the solid chemical reservoir, the recirculation circuit being configured to draw liquid from the solution reservoir and discharge the liquid through the outlet of the recirculation line into the liquid filling space, thereby causing the liquid to flow through the plurality of apertures of the product support surface to contact the solid chemical thereon before discharging through the liquid outlet opening back into the solution reservoir.

2. The system of claim 1, wherein:
the plurality of apertures of the product support surface are configured to allow diluent to flow upwardly therethrough; and
the recirculation circuit is configured to cause the liquid to flow upwardly through the plurality of apertures of the product support surface to contact the solid chemical thereon before discharging through the liquid outlet opening.

3. The system of claim 1, wherein the liquid outlet opening of the solid chemical reservoir is offset from the product support surface a distance within a range from 35 mm to 75 mm.

4. The system of claim 1, wherein a ratio of an area of the product support surface divided by a distance the liquid outlet opening of the solid chemical reservoir is offset from the product support surface is within a range from 1600 to 2600.

5. The system of claim 1, wherein:
the solution reservoir has a body extending from an open top end to a closed bottom end; and
the solid chemical reservoir is partially but not fully inserted into the open top end of the solution reservoir such that the liquid outlet opening is positioned inside of the solution reservoir.

6. The system of claim 5, wherein the solid chemical reservoir defines a first lengthwise portion having a cross-sectional area sized smaller than the open top end of the solution reservoir and a second lengthwise portion having a cross-sectional area sized larger than the open top end of the solution reservoir, wherein the first lengthwise portion is less than 25% of an overall length of the solid chemical reservoir.

7. The system of claim 5, further comprising:
a sealing gasket at a junction between the solution reservoir and the solid chemical reservoir; and
a gas-sealed overflow port in fluid communication with the solution reservoir.

8. The system of claim 5, wherein:
the solution reservoir defines an upper section having a first cross-sectional area and a lower section having a second cross-sectional area less than the first cross-sectional area;
the lower section is aligned with a first portion of the upper section and is offset from a second portion of the upper section to define a cavity that the second portion of the upper section extend over; and
the recirculation pump is located in the cavity.

9. The system of claim 1, wherein the liquid outlet opening comprises at least two liquid outlet openings extending through the at least one sidewall on substantially opposite sides of the solid chemical reservoir.

10. The system of claim 1, further comprising a controller configured to:
control addition of water to the solution reservoir to a level below the liquid blocking wall;
control the recirculation circuit to recirculate liquid from the solution reservoir to the outlet of the recirculation line into the liquid filling space; and
control discharge of a generated chemical solution from the solution reservoir.

11. The system of claim 1, further comprising a delivery line connected to the recirculation line via a metering valve, wherein the recirculation pump is operable to deliver the generated chemical solution from the solution reservoir to a downstream location via the delivery line.

12. The system of claim 1, wherein the liquid blocking wall is connected to the at least one sidewall of the solid chemical reservoir and forms a bottom surface of the solid chemical reservoir, and the product support surface is retained in an interior of the solid chemical reservoir offset form the liquid blocking wall.

13. The system of claim 12, wherein:
the product support surface is connected to at least one upwardly extending sidewall to define solid product support basket;
the solid product support basket is inserted into the interior of the solid chemical reservoir; and
the at least one upwardly extending sidewall of the solid product support basket defines an opening aligned with the liquid outlet opening extending through the at least one sidewall of the solid product reservoir.

14. The system of claim 1, wherein the liquid blocking wall comprises one or more apertures extending through the liquid blocking wall that are configured to allow liquid to drain through the liquid blocking wall after liquid delivery by the recirculation pump is terminated.

15. A method comprising:
introducing a solid chemical into a solid chemical reservoir comprising at least one sidewall and a liquid outlet opening extending through the at least one sidewall;
introducing water into a solution reservoir positioned vertically below the solid chemical reservoir;
recirculating liquid from the solution reservoir by drawing the liquid from the solution reservoir and discharging the liquid through an outlet of a recirculation line into a liquid filling space positioned between a product support surface on which the solid chemical resides and a liquid blocking wall, thereby causing the liquid to flow through a plurality of apertures of the product support surface and to contact the solid chemical thereon before discharging through the liquid outlet opening and back into the solution reservoir; and
discharging a generated chemical solution from the solution reservoir to a downstream location.

16. The method of claim 15, wherein recirculating liquid comprises causing the liquid to flow upwardly through the plurality of apertures of the product support surface and to contact the solid chemical thereon.

17. The method of claim 15, wherein the liquid outlet opening of the solid chemical reservoir is offset from the product support surface a distance less than 100 mm.

18. The method of claim 15, wherein a ratio of an area of the product support surface divided by a distance the liquid outlet opening of the solid chemical reservoir is offset from the product support surface is within a range from 1600 to 2600.

19. The method of claim 15, wherein the solid chemical reservoir is partially inserted into the solution reservoir with the liquid outlet opening positioned below an upper end of the solid chemical reservoir.

20. The method of claim 15, wherein introducing water into the solution reservoir comprises introducing water into the solution reservoir until the water reaches a target level below the liquid blocking wall.
